(19) United States
(12) Patent Application Publication
(10) Pub. No.: US 2013/0120831 A1
(43) Pub. Date: May 16, 2013

(54) OPTICAL AMPLIFIERS

(71) Applicants: Ian Peter McClean, Brixham (GB); Nadhum Kadhum Zayer, Newton Abbot (GB); Barrie Flintham, Totnes (GB); Jonathan Stuart Drake, Paignton (GB)

(72) Inventors: Ian Peter McClean, Brixham (GB); Nadhum Kadhum Zayer, Newton Abbot (GB); Barrie Flintham, Totnes (GB); Jonathan Stuart Drake, Paignton (GB)

(73) Assignee: Oclaro Technology Limited

(21) Appl. No.: 13/697,776

(22) PCT Filed: May 11, 2011
(86) PCT No.: PCT/GB11/50900

§ 371 Date: Jan. 23, 2013

(30) Foreign Application Priority Data
May 13, 2010 (GB) 1008003.4

(51) Int. Cl. H01S 3/067

(52) U.S. Cl. CPC H01S 3/06754
USPC 359/341.3

(57) ABSTRACT

An optical amplifier system is provided which comprises first and second optical amplifiers (1, 2) for amplifying optical signals in a fibre optic communications link and a common pump (3) for optically pumping both the first amplifier (1) and the second amplifier (2) to effect such amplification. There is also provided an optical switch (6) for providing an optical path between the pump and the first amplifier in a first switching state and an optical path between the pump and the second amplifier in a second switching state to enable pumping of the first and second amplifiers by the pump sequentially. Advantageously this arrangement provides high accuracy to the outputs (4, 5) of the pump (3) and reduces low power pump noise.

The invention relates to optical amplifiers and is concerned more particularly, but not exclusively, with multiple Er coil and/or gain stage erbium doped fibre amplifiers (EDFAs).

### BACKGROUND

In many EDFA designs two pumps are required to produce a low noise figure (NF) and high optical output powers. This is for example shown in FIG. 1, which is a schematic illustration of an EDFA comprising two pump stages 1 and 2. Each pump stage comprising one separate pump laser (3 for the first pump stage 1 and 4 for the second pump stage 2). FIG. 2 is also a schematic representation of an EDFA having two pump stages 1 and 2. Many features of FIG. 2 are similar to those of FIG. 1, but without the mid-span access area 5. These are required to allow the inclusion of devices like add-drop multiplexers (MUXES) or a dispersion compensator. For both the arrangements of FIGS. 1 and 2, one separate pump laser 3 and 4 is required in each stage 1 or 2 to provide an accurate pump power. These are also required to optimise the static performance such as power and NF as well as dynamic control under transient input conditions. EDFAs are used in many differing input conditions where the ratio of power required to each pump will vary to maintain optimum performance, for example on the one hand where the amplifier is used with a single low power input channel or on the other hand where the input consists of a fully loaded channel count with high optical power. The need for two pumps increases cost and the physical size of implementation.

Also there are application systems where two amplifiers are used in opposite directions, namely bi-directional (Bi-Di) amplifiers. The control of each amplifier is optimally achieved with separate controls and pump insertion powers. In this case changing the pump power of one amplifier must not affect the output power of the second amplifier. This would generally dictate the need to use two separate pumps.

A technique has been demonstrated where a Si planar lightwave circuit (PLC) is used to split the power from a single pump into two paths of variable output power. However this does not provide improved low power control.

It has been further demonstrated in WO2009112504 that the output from a single pump may be split into two ports and the power of the second port is varied in amplitude to provide variable control. However this strategy fails to provide optimum amplifier performance in terms of low power pump noise, and also does not address the Bi-Di amplifier requirement.

U.S. Pat. No. 7,110,167 discloses an optical amplifier system comprising a pump laser pumping a gain medium. Pumping is mainly controlled conventionally by an electronic unit, which increases cost and the physical size of the system.

Thus there is a need for cost effective multiple stage amplifiers in order to reduce low power pump noise.

It is an object of the present invention to provide a simple and cost effective design for such an amplifier system in order to reduce low power pump noise.

### SUMMARY

According to one aspect of the invention there is provided an optical amplifier system comprising:
(i) first and second optical amplifiers for amplifying optical signals in a fibre optic communications link,
(ii) a common pump for optically pumping both the first amplifier and the second amplifier to effect such amplification,
(iii) switching means for providing an optical path between the pump and the first amplifier in a first switching state and an optical path between the pump and the second amplifier in a second switching state to enable optical pumping of the first and second amplifiers by the pump sequentially.

Advantageously, this invention provides the benefit of using a single or common pump for pumping two amplifiers having two Er coil gain stages. The amplifier system optically reduces low power pump noise and addresses the Bi-Di amplifier requirement. Furthermore, the optical switching means reduces the physical size requirements of an optical package. It therefore saves cost and provides an advantage over the prior art.

Preferably the switching means includes an input coupled to the pump and outputs coupled to the first amplifier and the second amplifier. This enables the user to independently change the power supplied to one of the first and second amplifiers without impacting the power supplied to one other of the first and second amplifiers.

Conveniently the switching means is adapted to vary the power supplied to one of the first and second amplifiers from 0% to maximum pump power. Preferably, the switching means is adapted to supply the maximum pump power to the other of the first and second amplifiers. This enables two variable pump powers to be supplied to the first and second amplifiers from the single pump laser via the outputs of the switching means.

The switching means may comprise an optical switch having at least two outputs and preferably incorporates a pulse width modulation (PWM) unit. Using the PWM unit and the optical switch in combination provides a high accuracy of the independent outputs of the optical switch.

Preferably a grating is coupled to an input or an output of the switching means so as to lock the optical path between the pump and the first amplifier in the first switching state and to lock the optical path between the pump and the second amplifier in the second switching state. This enables two independent locked outputs to be provided from a common pump laser. The locked outputs ensure that a consistent pump wavelength is applied to the Er fibre for providing consistent gain shape control of an EDFA.

According to another aspect of the invention there is provided a method of controlling an optical amplifier system comprising:
(i) amplifying optical signals in a fibre optic communications link by means of first and second optical amplifiers;
(ii) optically pumping both the first amplifier and the second amplifier by means of a common pump to effect such amplification, and
(iii) providing an optical path between the pump and the first amplifier in a first switching state and an optical path between the pump and the second amplifier in a second switching state to optically pump the first and second amplifiers sequentially.

### BRIEF DESCRIPTION OF THE DRAWINGS

In order that the invention may be more fully understood, a number of embodiments of the invention will now be described, by way of example, with reference to the accompanying drawings, in which:

FIG. 1 is a schematic illustration of a known dual stage EDFA having one pump in each Er coil gain stage;

FIG. 2 is a schematic illustration of a known mid-span access dual stage EDFA;

FIG. 3 is a schematic illustration of a single pump dual Er coil gain stage EDFA;

FIG. 4 is a schematic illustration of a single pump dual Er coil gain stage EDFA having power control in each output port of the pump;

FIG. 5 is a schematic illustration of single pump dual Er coil gain stage EDFA design with a fast optical switch;

FIG. 6a to FIG. 6f show the mark-to-space ratio for the optical switch at variable output port powers;

FIG. 7a shows the mark-to-space ratio for the PWM signal on the pump and on the switch at a constant power;

FIG. 7b shows the mark-to-space ratio for the optical switch at a power of 50 mW, and

FIG. 8 is a schematic illustration of an optical amplifier system in which the optical switch is placed between a pump laser chip and a grating.

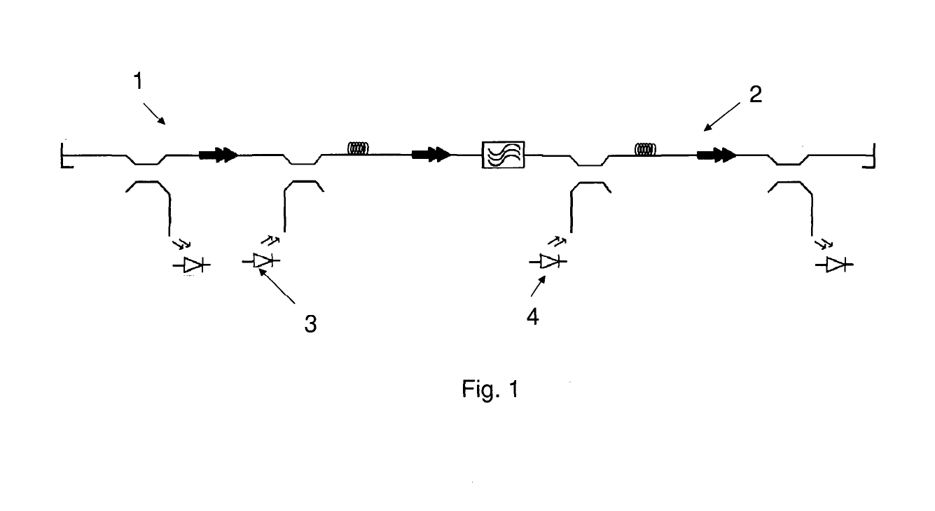

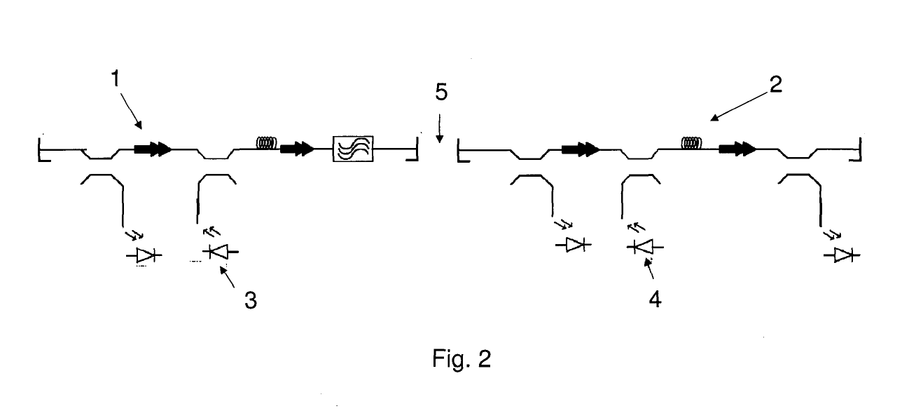

### DETAILED DESCRIPTION

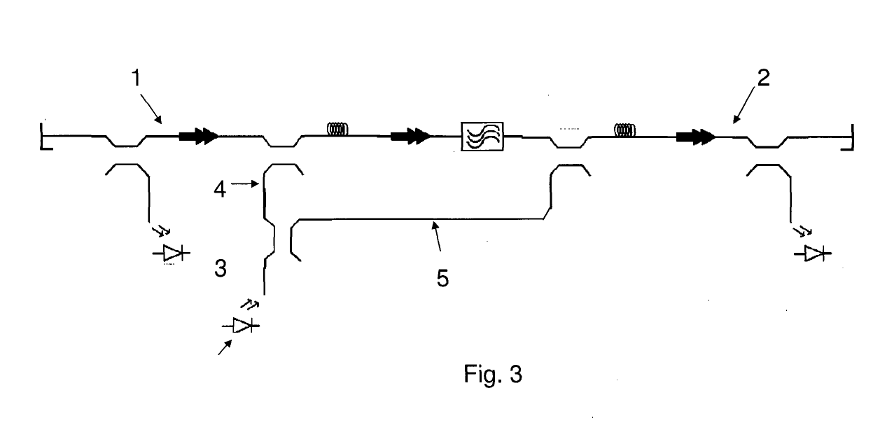

FIG. 3 is a diagrammatic illustration of a single pump dual Er coil gain stage EDFA. There are provided two pump stages having a first amplifier 1 comprising a single Er coil and a second amplifier 2 comprising a single Er coil. In order to allow the use of one pump in more than one Er coil gain stage, a high power single pump laser 3 is provided instead of two separate pump lasers. The pump laser 3 comprises two output ports 4, 5 coupled to the first and second amplifiers 1 and 2 respectively. The inventors have appreciated that the power ratio between each stage is fixed, so that this arrangement may not provide optimum performance over all operating conditions and may restrict the maximum power supplied from each output port 4, 5 of the pump laser 3.

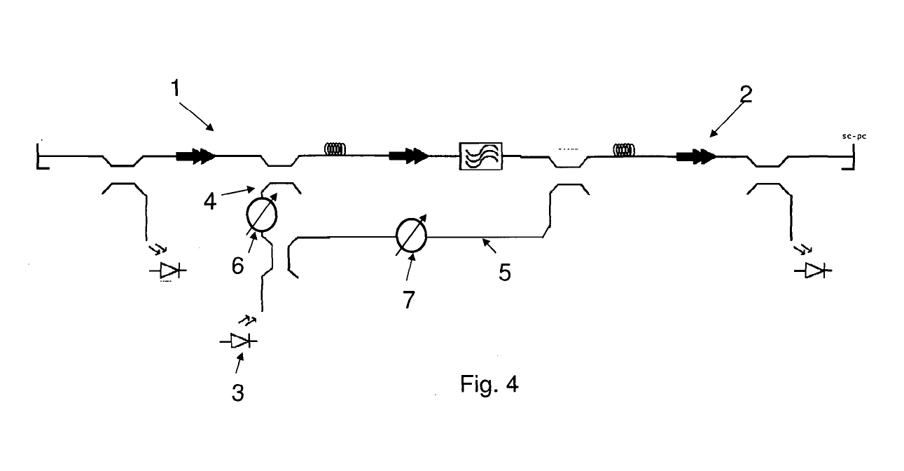

FIG. 4 is a diagrammatic illustration of a single pump dual Er coil gain stage EDFA with per pump power control. Many features of FIG. 4 are similar to those of FIG. 3 but without a pump attenuator 6, 7 in each output port 4, 5. The power loss in each output port 4, 5 is controlled by the attenuator 6, 7. The inventors have appreciated that this arrangement may produce larger pump loses and may restrict the maximum pump power in each output port 4, 5 to only that allowed by the split ratio.

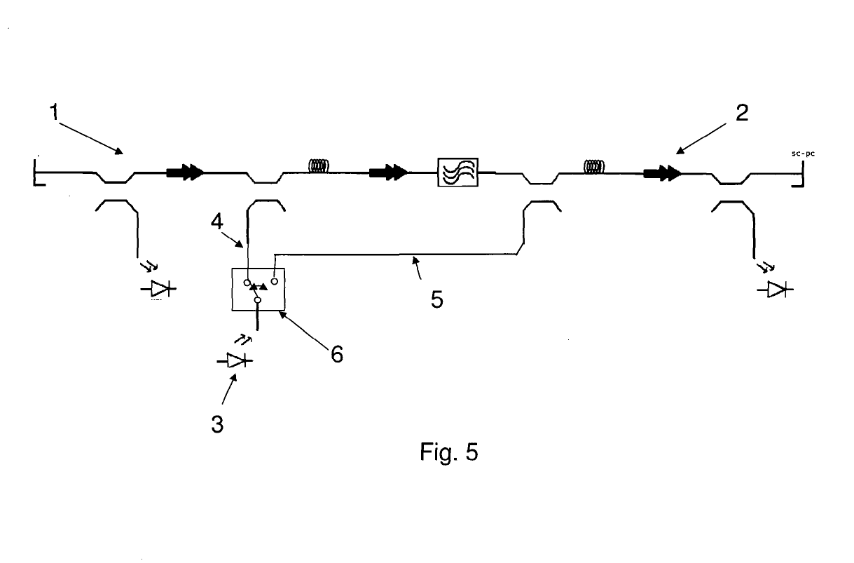

FIG. 5 is a schematic illustration of a single pump dual Er coil gain stage design with a fast optical switch 6. The inventors have recognised that a possible solution to the problems stated for the arrangement of FIGS. 3 and 4 is to provide an optical switch between the pump 3 and the output ports 4, 5 coupled to the first and second amplifiers 1, 2 respectively. The optical switch 6 therefore provides an optical path between the pump 3 and the first and second amplifiers 1, 2. The optical switch 6 is controlled by a PWM unit and an electronic unit (not shown in FIG. 5) to vary the power ratio between the two output ports 4, 5 so that the average power supplied from either output port 4, 5 can be varied from 0% to 100% with the other port supplying an opposite power using a relevant control scheme.

An important characteristic of this technique is to be able to change the power of each pump port 4, 5 from 0% to maximum power without impacting the power supplied from the other port. This can be achieved in one or more ways. Firstly, by varying the power of the pump laser 3, as well as the mark to space ratio, it is possible to change the power of either or both output ports 4, 5 from 0% to full power or the maximum power which is set to the other port.

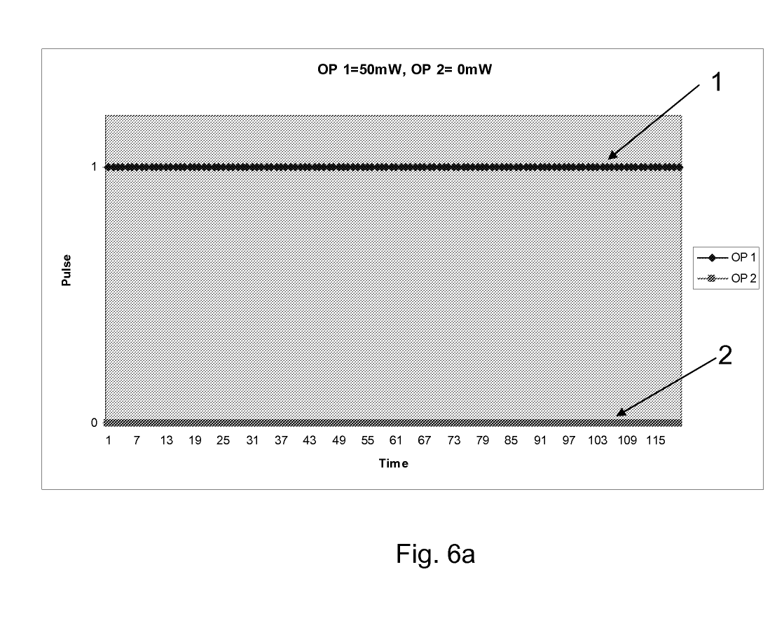

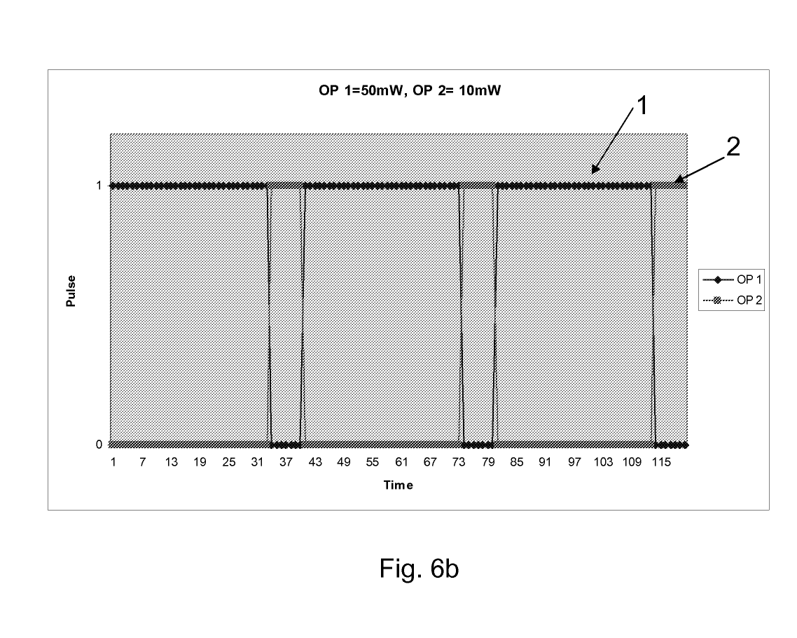

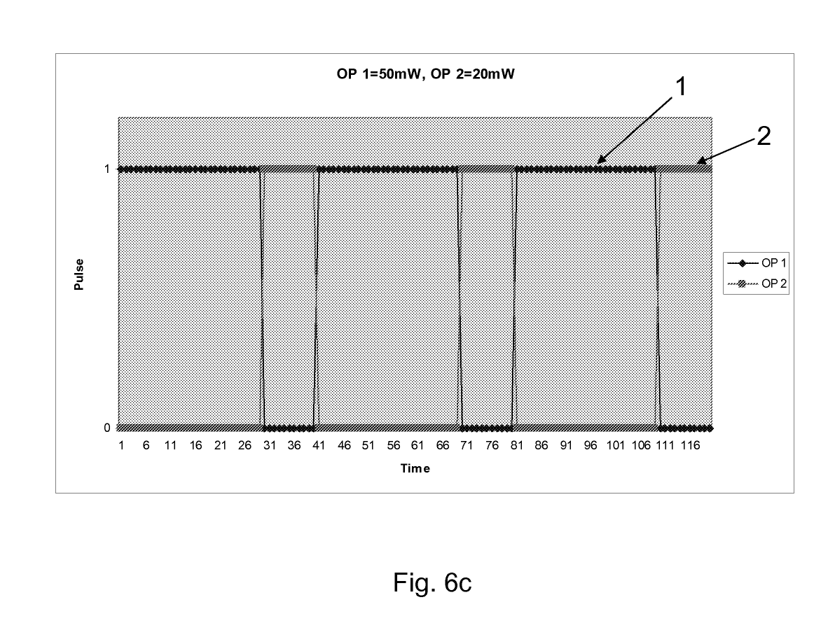

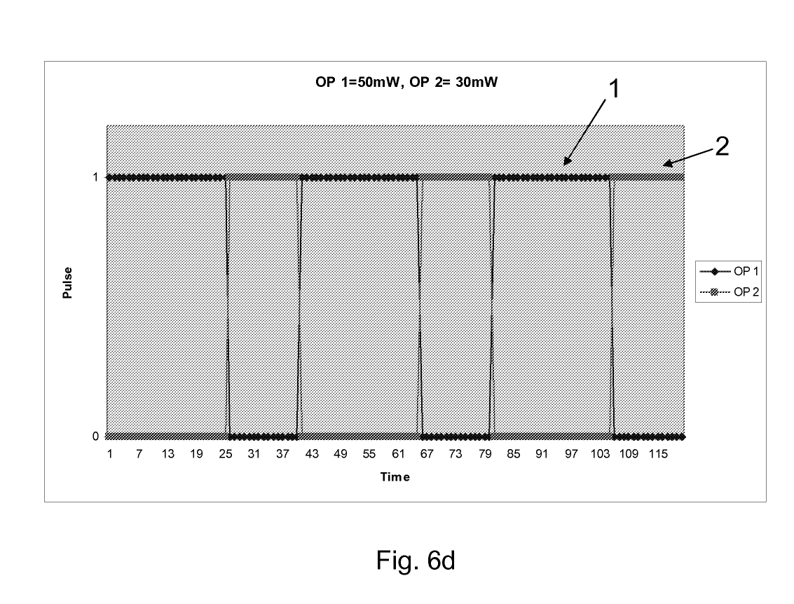

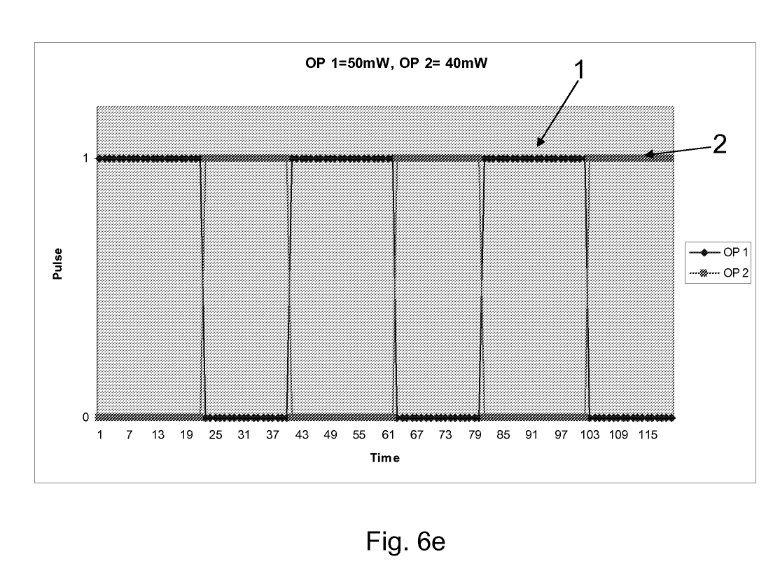

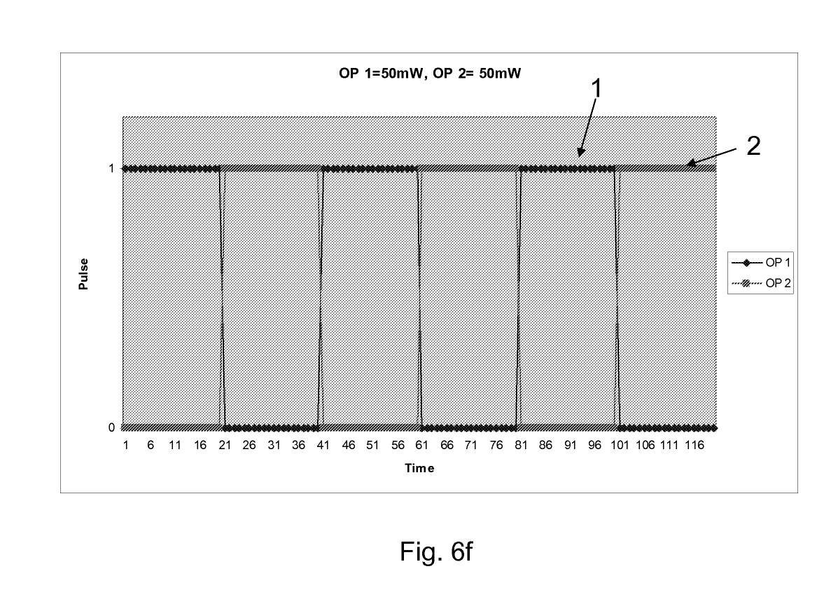

Examples of this technique are shown in FIGS. 6a to 6f which illustrate the mark-to-space ratio of the output port 1 (curve 1) and the output port 2 (curve 2) of the optical switch at variable output port powers. In these figures, the power of output port 1 is fixed at 50 mw and the power of output port 2 is varied in 10 mW steps from 0 mW to 50 mW assuming that the total pump power is 100 mW. This technique requires the period of the PWM unit to be split into a number of equal sized steps which is carried out by the electronic unit. The more steps the more accurate the control is. However it will be appreciated that this also leads to a much slower control scheme in setting the variable pump power. Accuracies in setting a variable pump power in this example with 40 steps may be within 2% of the target. The inventors have recognised that a way to improve this is to modulate the pump laser with the PWM as well as the optical switch. This combination results in a better control scheme in setting a variable pump power.

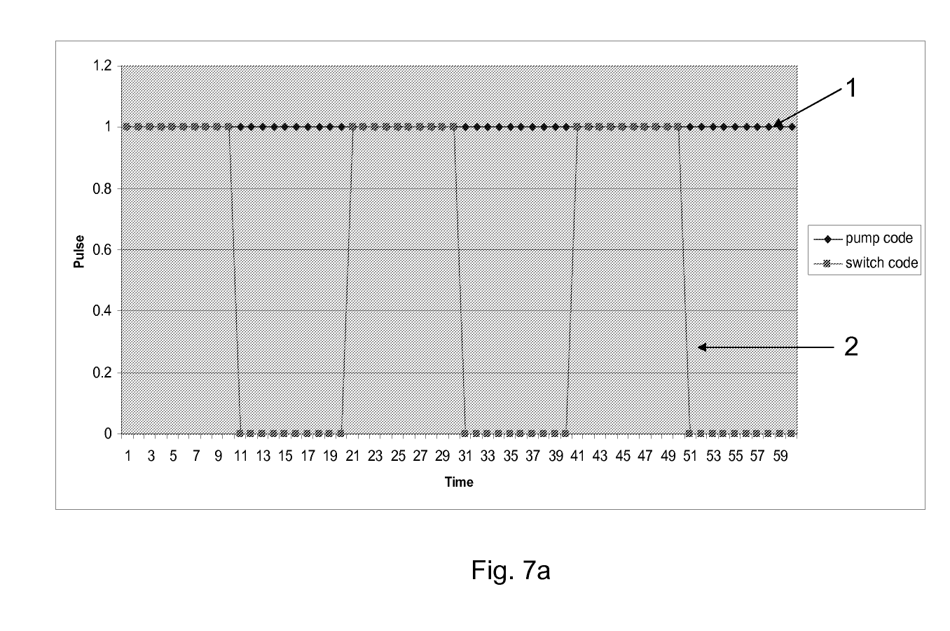

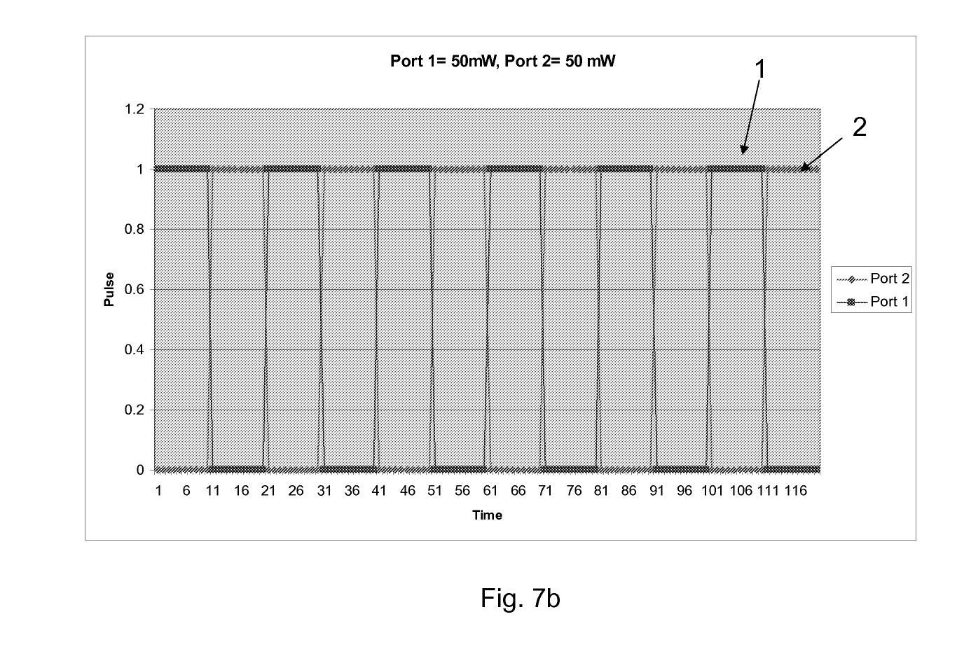

Examples of the technique involving a pump power scheme using the PWM unit and a switch scheme using the optical switch in combination are shown in FIGS. 7a and 7b. FIG. 7a shows the mark-to-space ratio using pump code (curve 1) and switch code (curve 2) at a power of 100 mW. FIG. 7b shows the mark-to-space ratio of output port 1 (curve 1) and output port 2 (curve 2) when a power of 50 mW is supplied from the output ports. Similar as to the arrangement shown in FIGS. 6a to 6f, the power of output port 1 is fixed at 50 mW and the power of output port 2 is varied in 10 mW steps from 0 mW to 50 mW assuming that the total pump power is 100 mW. With this combinational technique, accuracies of the control scheme in setting the variable pump power are improved as only a 20 step scheme is used by contrast with the 40 step scheme used for the arrangement of FIGS. 6a to 6f. This technique also gives the advantage of being able to run the pump above kink as can be achieved with the platform incorporating control scheme as defined in US07110167 to get higher pump output power.

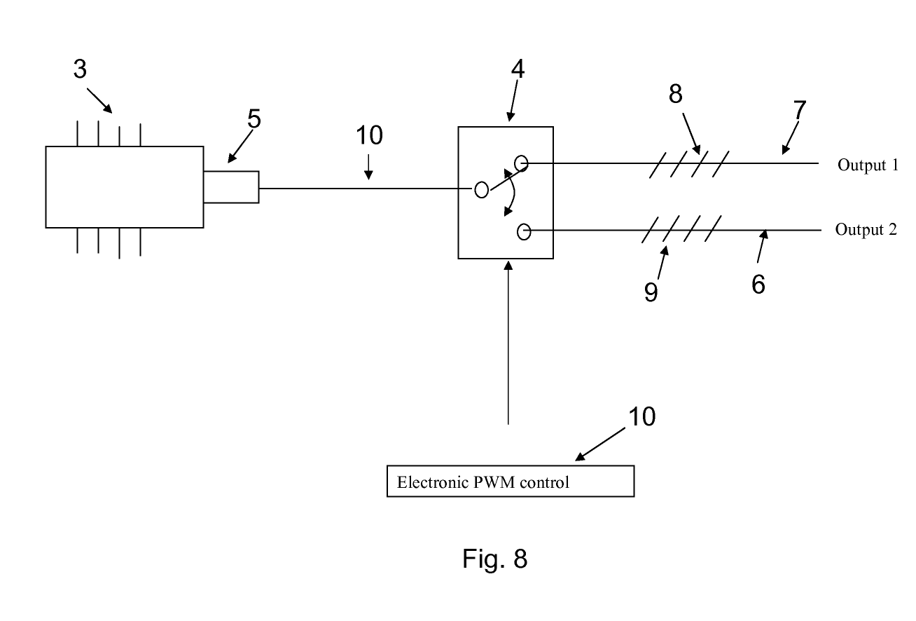

FIG. 8 is a schematic illustration of an optical amplifier system in which the optical switch is placed between a pump laser chip and a grating. A fibre 5 from the output of a standard pump laser 3 is connected to the input 10 of a fast optical switch 4. The two fibre outputs 6, 7 of the switch 4 are connected to two individual gratings 8, 9 so that at any time when the switch 4 is on there is a defined optical path between the pump laser 3 and the grating 8 or 9 so that frequency locking can occur. As a result, the pump laser 3 also has an output from the locked path. The output fibres 6, 7 join the optical amplifier in a conventional way. The optical switch 4 is controlled via an electronic unit 10, possibly using a FPGA or a fast processor or a discrete digital circuit or an analogue scheme. It will be appreciated that the grating 8, 9 can also be placed before the optical switch 4. In such an arrangement, the grating would be coupled to the output fibre 5 of the laser 3 and the input 10 of the optical switch 4. The grating 8, 9 used in either path can be the same or of different wavelengths. Using gratings with different wavelengths ensures improved performance from using different pump wavelengths into different gain stages of the optical amplifiers.

It will be appreciated that the amplifier system design can be applicable to more than two outputs where three or more pump insertion points are required. For example a third pump insertion point may be included injecting pump power back into the final Er loop, known as counter pumping, to provide even higher pump output powers. Such an arrangement will need a 1×N switch design. In addition a 1×N switch could enable control of several amplifiers from a single pump this providing significant cost and space saving compared to the conventional design of a single pump per amplifier.

The type of switch to be used is key to the technique described for the arrangements of FIGS. 5 and 8. It will be appreciated that, in the most complex case, the switch needs to be fast and reliable. For example it needs to switch up to billions of times every minute. The target speed at a high output power is a switch period of the order of 0.1 μs which is fast enough to prevent a PWM pattern or sequence being modulated onto an optical amplifier gain (Er gain). In this case the optical switch operates faster than a low pass characteristic of the amplifier so that the pulse nature of the pump does not affect the gain performance. Furthermore, the sequence of the PWM unit is used in an optical scheme to prevent low power instabilities observed in some pump lasers, e.g. a 980 nm pump laser. Advantageously the use of this optical scheme saves the cost of the pump laser, and reduces the physical size requirements of the optical package.

It will be appreciated that a suitable switch can be a Mach-Zehnder (MZ) design. A GaAs MZ modulator, e.g. a 10 Gb/s data rate GaAs modulator, is suitable for this requirement. Advantageously this switch can be photonically integrated with the pump laser on the same chip and packaged together. This also improves the operational frequency and reliability of the device. A further benefit of the MZ approach is that multiple MZ modulators can be integrated (i.e. monolithically) together providing a 1×N switch output design. A further benefit of a MZ approach is that the output power of each port can be managed by simple DC control of the MZ ratio providing a simple control scheme.

It will be further appreciated that a nanospeed switch with fast rise and fall time (nanoseconds) can also be suitable as the optical switch. The repetition rate of these switches needs to be monitored to ensure switching in a given timeframe. The inventors have also appreciated that the switch is to be designed as small as possible to achieve the optimum performance.

As has been mentioned, two Er coil gain stages are required for single channel amplifiers having high gain operation, but due to size limitations a single pump is used that has a pump bypass scheme. The inventors have appreciated that this may not provide optimum performance in all possible operating conditions. Advantageously, the use of the switch scheme as described hereinbefore can improve the performance in various operating conditions. Furthermore, there is an emerging need for arrayed amplifiers that will require many pump lasers. The use of the switch scheme with a pump with two pump output ports would reduce the total number of pump devices used in a 4 amplifier matrix to 1 whilst giving accurate and independent pump control.

1. An optical amplifier system comprising:
(i) first and second optical amplifiers for amplifying optical signals in a fibre optic communications link,
(ii) a common pump for optically pumping both the first amplifier and the second amplifier to effect such amplification, and
(iii) switching means for providing an optical path between the pump and the first amplifier in a first switching state and an optical path between the pump and the second amplifier in a second switching state to enable optical pumping of the first and second amplifiers by the pump sequentially,
wherein the switching means is adapted to independently vary the power supplied to one of the first and second amplifiers from 0% to maximum pump power.

2. An optical amplifier system according to claim 1, wherein the switching means includes an input coupled to the pump and outputs coupled to the first amplifier and the second amplifier.

3. An optical amplifier system according to claim 1, further comprising a grating coupled to an input or an output of the switching means so as to lock the optical path between the pump and the first amplifier in the first switching state and to lock the optical path between the pump and the second amplifier in the second switching state.

4. (canceled)

5. An optical amplifier system according to claim 1, wherein the switching means is adapted to supply the maximum pump power to the other of the first and second amplifiers.

6. An optical amplifier system according to claim 1, wherein the switching means is adapted to vary the mark-to-space ratio of the optical signal supplied by the pump so as to vary the power supplied to one of the first and second amplifiers.

7. An optical amplifier system according to claim 1, wherein the switching means comprises an optical switch having at least two outputs.

8. An optical amplifier system according to claim 1, wherein the switching means incorporates a pulse width modulation (PWM) unit.

9. An optical amplifier system according to claim 1, wherein the switching means incorporates an analogue control scheme.

10. An optical amplifier system according to claim 1, wherein the switching means incorporates a digital control scheme.

11. An optical amplifier system according to claim 1, wherein the switching means includes an electronic unit.

12. An optical amplifier system according to claim 1, wherein the switching means is configured to operate at a frequency with a switching period of the order shorter than the pump to output power transfer function.

13. An optical amplifier system according to claim 1, wherein the switching means is a GaAs Mach-Zehnder (MZ) modulator.

14. An optical amplifier system according to claim 1, wherein the switching means is a multiple set of GaAs Mach-Zehnder (MZ) modulators.

15. An optical amplifier system according to claim 13, wherein the MZ modulator is photonically integrated with the pump on the same chip.

16. An optical amplifier system according to claim 1, wherein the pump comprises a pump laser diode.

17. A method of controlling an optical amplifier system comprising:
(i) amplifying optical signals in a fibre optic communications link by means of first and second optical amplifiers,
(ii) optically pumping both the first amplifier and the second amplifier by means of a common pump to effect such amplification,
(iii) providing an optical path between the pump and the first amplifier in a first switching state and an optical path between the pump and the second amplifier in a second switching state to optically pump the first and second amplifiers sequentially, and
(iv) varying the average power supplied to one of the first and second amplifiers from 0% to the maximum pump power.

18. A method according to claim 17, further comprising:
controlling switching by using a pulse width modulation (PWM) technique.

19. A method according to claim 18, further comprising varying the mark-to-space ratio of the optical signal supplied by the pump so as to vary the power supplied to one of the first and second amplifiers.
